(19) United States
(12) Patent Application Publication
(10) Pub. No.: US 2014/0250024 A1
(43) Pub. Date: Sep. 4, 2014

(54) FORMATTING SYSTEM AND METHOD FOR PRODUCING A STANDARDIZED RESUME

(71) Applicant: Murali G Takalpati, Morrisville, NC (US)

(72) Inventor: Murali G Takalpati, Morrisville, NC (US)

(21) Appl. No.: 13/784,114

(22) Filed: Mar. 4, 2013

(51) Int. Cl. G06Q 10/10

(52) U.S. Cl. CPC G06Q 10/1053
USPC 705/321

(57) ABSTRACT

The present invention is a system for taking a resume up loading it to the internet to produce a new resume which is reformatted to desired format.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent tiles or records, but otherwise reserves all copyright rights whatsoever.

### BACKGROUND OF THE INVENTION

1. Field of the Invention

The present invention relates to resumes. In particular, it relates to a system and method for converting a job applicant candidate resume to a particular standardized resume format for use by a recruiting agency or the like over the internet.

2. Description of Related Art

Recruiting agencies, employment agencies, HR Software, outsourcing companies and the like help match those trying to find employment with employers. These agencies are useful because of the difficulty in employers and employees matching up. In addition, agencies usually help their candidates by working with them to improve the presentation they make to the prospective employer, no matter what the job. The employer on the other hand, will use such agencies, in addition to the stock of candidates, because the presentation is much more consistent and something employers can count on.

One thing that most agencies do is take the resume of the potential candidate they are working with and put the information to their own specific format, including typeface, layout, headings sections to be displayed, type of bullets, positioning, logos, header information and the like. Further, they add their own contact information to make sure the employer knows where the resume comes from and that there will likely be a charge for hiring the person. This is also done to prevent the prospective employer from directly contacting the employment candidate. Since there is no standard resume that such agencies receive, someone at the agency must take the time to transfer the information from one to the other and produce a new resume. This is a labor intensive process and such time that could be otherwise utilized is lost. It would be useful if there was an easier method for producing a reformatted standardized resume.

### BRIEF SUMMARY OF THE INVENTION

The present invention relates to the discovery that a useful system and method of dealing with the problems of resumes can be overcome by having an online (internet) system which can have a resume uploaded and will produce a new resume formatted to the users desired formatting requirements.

In one embodiment of the present invention, there is a computer internet implemented method of reformatting a job candidate's resume for a user comprising
a) the user selecting a standard resume format information, the format information comprising sections located in a particular location on the resume;
b) loading the standard resume format information onto a server connected to the internet;
c) uploading a digital copy of the job candidate's resume to be reformatted to the server using and input device;
d) the server processing the candidate resume by identifying the format information of the candidate resume comprising sections;
e) the server taking the identified sections, and converting them to the standard resume format to produce a reformatted resume; and
f) delivering a digital version of the reformatted resume for the users use.

In another embodiment, there is a computerized system for reformatting a job candidate resume over the internet for a user comprising
a) a internet connected server;
b) an input device for selecting a standard resume format information, the format information comprising sections located in a particular location on the resume, to the server over the Internet;
c) an input device for inputting the job candidate resume to the server over the internet;
d) computer readable medium in the server having program code which processes the candidate resume by identifying the format information of the candidate resume comprising sections, and taking the identified sections, and converting them to the standard resume format to produce a reformatted resume;
e) a delivery device in the server which can deliver a digital copy of the reformatted resume for the user.

### BRIEF DESCRIPTION OF THE DRAWINGS

FIG. 1 is a relationship chart of the system of the present invention.

FIG. 2 is a flow chart of the method of the present invention.

FIG. 3 is a webpage screen shot registration page for the system of the present invention.

FIG. 4 is a website screen shot format selecting page for the system of the present invention.

FIG. 5 is a website screen shot header/footer selection page for the system of the present invention.

FIG. 6 is a website screenshot section/organization page for the system of the present invention.

### DETAILED DESCRIPTION OF THE INVENTION

While this invention is susceptible to embodiment in many different forms, there is show in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

### DEFINITIONS

The terms “about” and “essentially” mean ±10 percent.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language Any invention using the term comprising could be separated into one or more claims using “consisting” or “consisting of” claim language and is so intended.

Reference throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are for the purpose of illustrating certain convenient embodiments of the present invention, and are not to be considered as limitation thereto. Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein the term “resume” refers to a representation used by a person to present their background and skills. It is used to divide into sections with titles such as education, experience, etc. As used herein the term resume could include one or more such representations from one or more people.

As used herein the term “computer Internet implemented” refers to a system and method wherein there is a server with a connection to the internet. In addition, the user of the system and the candidate with a resume will access the system via the internet and thus have a computer available to access the server via the internet. In addition when a copy of the resume is ready a device for down loading/printing the reformatted resume is one embodiment.

As used herein the term “user” refers to an employment agency, recruiting agency, human resources professional or the like. This agency has need of a standardized resume in both form, style, font etc. In some embodiments, the term refers to a company or employer who is directly using the service for example when the candidate loads the resume into the system a hiring department in the employer may want all resumes in a particular format.

As used herein the term “standard resume format information” refers to the user deciding which features in a resume they would like to indicate predetermine or the like as standard for the users resumes to be converted to from the candidate resume. In general there will be sections of information, as selected by the user such as but not limited to type face, font, styles, logos, placement and the like which all go into the production of the resume. Some of this information will be supplied by the user while much of it will be taken from the candidate resume and combined to form the reformatted resume.

As used herein, the term“computer readable medium” refers to any device or system for storing and providing information (e.g., data and instructions) to a computer processor. Examples of computer readable media include, but are not limited to, DNDs, CDs, hard disk drives, magnetic tape and servers for streaming media over networks. As used herein, the term :encode: refers to the process of converting one type of information or signal into a different type of information or signal to, for example, facilitate the transmission and/or interpretability of the information or signal. For example, image files can be converted into (i.e., encoded into) electrical or digital information. Likewise, light patterns can be converted into electrical or digital information that provides an encoded video capture of the light patterns.

As used herein, the term “Internet” refers to any collection of networks using standard protocols. For example, the term includes a collection of interconnected (public and/or private) networks that are linked together by a set of standard protocols (such as TCP/IP, HTTP, and FTP) to form a global, distributed network. While this term is intended to refer to what is now commonly known as the Internet, it is also intended to encompass variations that may be made in the future, including changes and additions to existing standard protocols or integration with other media (e.g., television, radio, etc.). The term is also intended to encompass non-public networks such as private (e.g. corporate) Intranets.

As used herein, the terms “computer memory” and “computer memory device” refer to any storage media readable by a computer processor. Examples of computer memory include, but are not limited to, RAM, ROM, computer chips, digital video discs (DND), compact discs (CDs), hard disk drives (HDD), and magnetic tape.

As used herein, the terms “input device” and “delivery device” include, but are not limited to, set-top boxes (e.g., DSTBS), personal computers (PCs), cellular telephones, and minicomputers, whether desktop, laptop, or otherwise, and mobile devices such as handheld computers, PDAs, personal media devices (PMDs), and smartphones. Delivery devices can also include printers and the like.

As used herein the term “server” refers to any computerized component, system or entity regardless of form that is adapted to provide data, files, applications, content, or other services to one or more other devices or entities on a computer network.

Examples of sections though not inclusive include for example:

SectionName
Full Name
Profile Picture
Contact Email
Contact Home Phone
Contact Mobile Phone
Contact Address1
Contact Address2
Contact City
Contact State
Contact Zip
Contact Country
Objective
Summary
Accomplishments
Skills
Employer Name
Job Start Date
Job End Date
Job Title
Job Description
Job Skills
Job Duties
Education
Certification
Awards
Publications
Accreditation
Licenses
Membership
Blog
Web Site
News
Social Profiles
Profile Videos
Reference Name
Reference Title
Reference Date
Reference Details
Work Experience
Qualifications
Leadership
Presentations/Speeches
Courses
Additional Information
Clients
Community Service
Dissertation
Extra-Curricular Activities
Interests
Languages
Keywords
Military Experience
Portfolio
Work Authorization
Patent/Patent Applications
Section Name

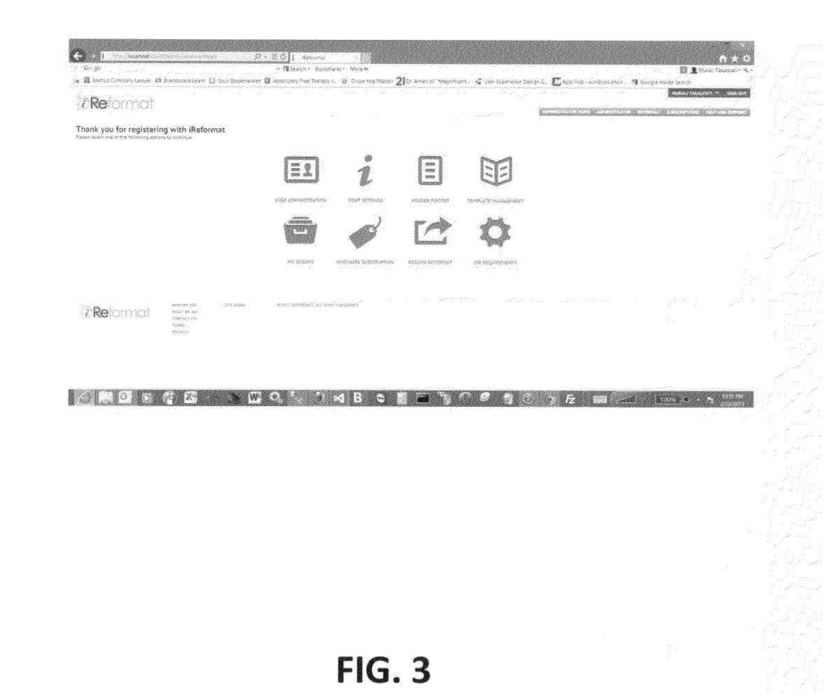

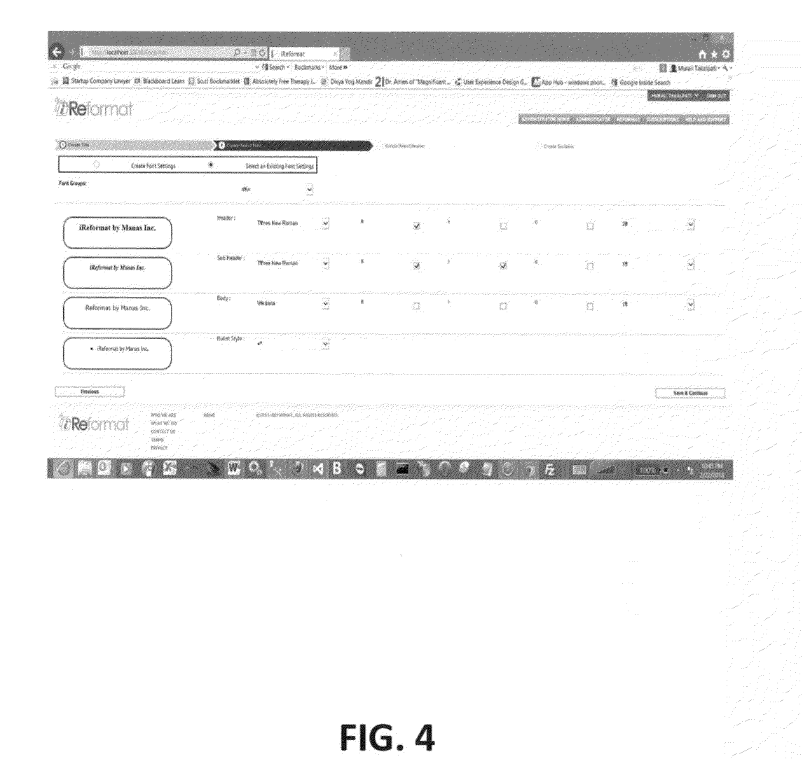

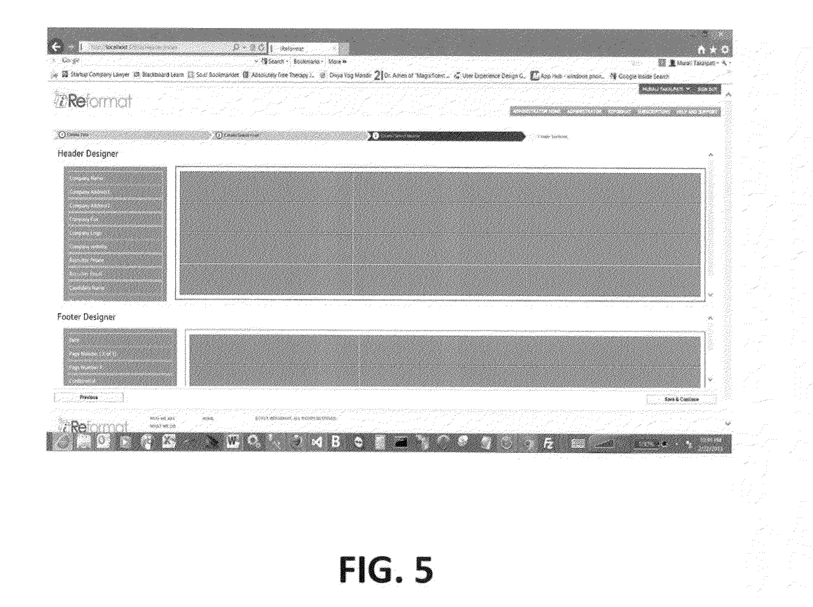

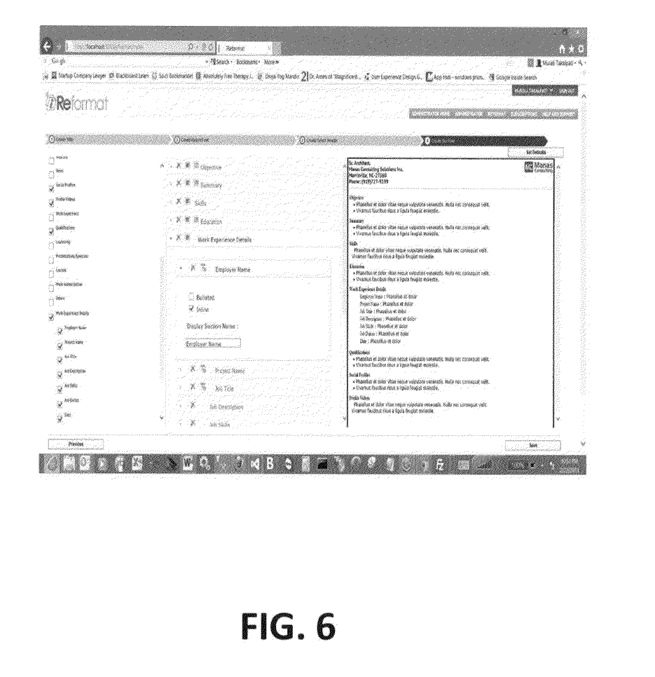

When creating a format, the user specifies font settings, header & footer settings, section display order and additional section specific display format settings. Font Settings include type face, bold, underline, italic, size, color and additional applicable settings. Header settings include positioning the agency name, address, contact phone, contact email logo, and website address. Placeholders for putting Job Candidate name, recruiter name, confidential date and page number. Also position the placeholders either left, middle or right. Section settings could be either to include all sections in the resume or only specific sections and in the specified order. Each section could have additional formatting options like always bulleted, always paragraph, left, right and center alignment. Certain sections like the skills section can be displayed as a matrix. Other format settings as desired can be individual and in view of this disclosure, would be within the skill in the art. A view of the example screen shots FIGS. 3-6 show further examples of headings, section and selecting format.

To make the Resume Formatting more targeted to specific Jobs, users can add a Job Descriptions to a web site so that the newly formatted resume's can be searched. The system can extract all the required skill keywords from the Job Description. If the Users want to highlight specific Skills/Keywords, they can add those keywords and associate it with that job Description. They can also specify if only the specific Skill/Keywords need to be highlighted or the complete sentences with the Skill/Keywords.

Typically, a User/Recruiter, once he is subscribed to this service and created the formats, will Upload the Resume/Document to reformat. Select one of the Predefined formats from a list, also if the document is reformatted for a specific Job that will also be selected from a list of available Job Descriptions. Using the format options created by the User, the Resume is Reformatted and made available as output for example, by one of the options like RTF, DOCX, PDF or TEXT.

As used herein a “job candidate's resume” refers to a job seeker having their own resume (or one supplied by a third party such as an outsourcing agency) who is applying for a job and is submitting their resume which then must be converted to a standardized formatted resume for further distribution to a potential employer. In general, the job candidate's resume must be converted to a digital format so that it can be uploaded to the server over the internet and converted by the system. The job candidate could do that directly, or in a case where a hard copy or a digital copy delivered to the agency, the agency could digitally upload the resume by known means to the server.

As used herein “server processing” refers to the server receiving a candidate resume and parsing the resume into the various sections components and the like. It can also include reading images, tables and any other metadata required to reproduce the document using the standardized resume format described earlier. Once the server has identified the different parts of the job candidate's resume, it can rearrange or convert them to the format of the standardized resume including any parts coming directly from the agency including agency information, job descriptions, and the like. Once that is complete, the server then creates a digital version of the resume that appears as a paper resume which then can be printed out or kept as a digital version of a paper resume for delivery for the users benefit as desired, i.e., delivery to the hiring manager.

The system of the present invention then for implementing the present method would then be a server connected to the internet associated with computer readable medium having programming code which processes (parses) the candidate resume by identifying the format information of the candidate resume comprising sections, fonts styles and the like and converting them to the standard resume format to produce a resume reformatted as desired. There are input devices for the user to input the standardized resume information and input devices for inputting the job candidate resume such as computer terminals with internet connections, scanners and the like. The digital conversion is done in a digital formatting creates a new digital resume which can be delivered to a printer for printing a regular style resume or sending one a copy of the resume which looks like a resume in a word processor program or the like.

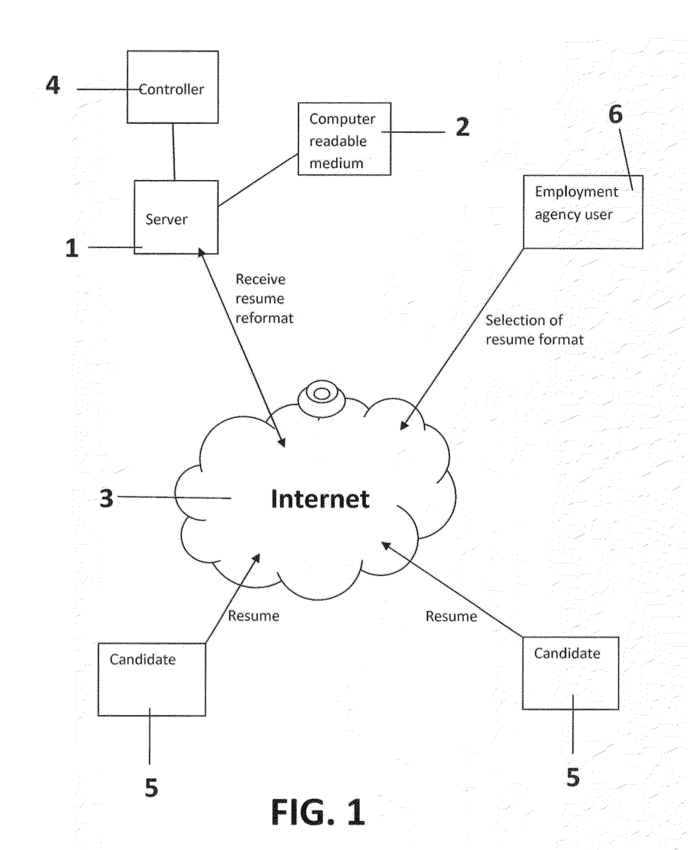

Now referring to the drawings, FIG. 1 is a relationship chart of the parts of the system of the present invention. A server 1 having associated therewith a computer readable medium 2 is placed in connection with the internet 3 by controller 4. The controller is the operator of the system over the internet. The computer readable medium having the code for converting the job candidate resume to the standardized formatting and the server as above. The internet 3 connection allows the server to receive the candidate resume from candidate 5 and the user 6 selection of the of the resume format.

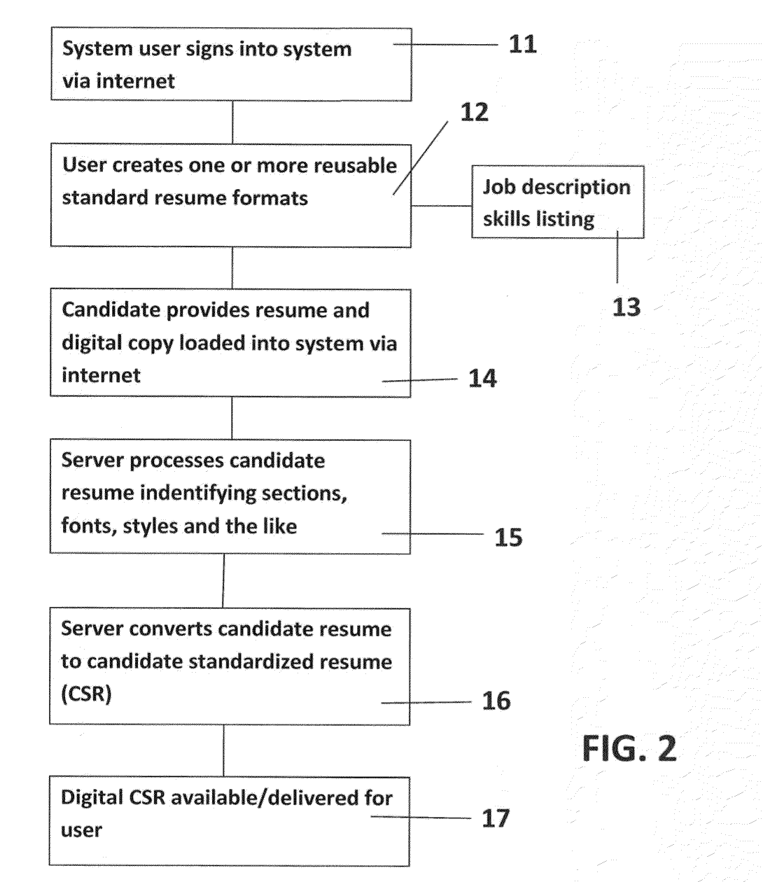

FIG. 2 outlines the basic steps of the method of the present invention. A system user signs onto the system via the internet 11. The user then creates one or more reusable standard resume formats 12. Optional job descriptions skills listings and the like are added 13. The candidate then provides a resume and a digital copy is loaded into the system via the internet 14. The server processes the candidate resume identifying the sections fonts styles and the like 16 on the candidate resume. The server converts the candidate resume to candidate standardized resume 16. Lastly, a digital candidate standardized resume is made available or delivered to the user's use 17.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials and the like apparent to those skilled in the art still fall within the scope of the invention as claimed by the applicant.

What is claimed is:

1. A computer internet implemented method of reformatting a job candidate's resume for a user comprising:
a) the user selecting a standard resume format information, the format information comprising sections located in a particular location on the resume;
b) loading the standard resume format information onto a server connected to the internet;
c) uploading a digital copy of the job candidate's resume to be reformatted to the server using an input device;
d) the server processing the candidate resume by identifying one or more sections in the job candidate resume;
e) the server taking the identified sections, and converting them to the standard resume format to produce a reformatted resume; and
f) delivering a digital version of the reformatted resume for the user's use.

2. The computer implemented method according to claim 1 wherein the reformatted resume is delivered to a prospective employer.

3. The computer implemented method according to claim 1 wherein the reformatted resume is delivered to the job candidate.

4. The computer implemented method according to claim 1 wherein the candidate resume is uploaded reformatted resume is delivered to a prospective employer.

5. The computer implemented method according to claim 1 wherein the internet server is accessed via an internet website.

6. A computerized system for reformatting a job candidate resume over the internet for a user comprising:
a) an internet connected server;
b) an internet connected input device for selecting a standard resume format information, the format information comprising sections located in a particular location on the resume, in memory on the server;
c) an internet connected input device for inputting the job candidate resume on to the server;
d) computer readable medium in the server having program code which processes the candidate resume by identifying the format information of the candidate resume comprising sections, and taking the identified sections, and converting them to the standard resume format to produce a reformatted resume; and
e) a delivery device in the server which can deliver a digital copy of the reformatted resume to at least one person.
